(19) United States
(12) Patent Application Publication
(10) Pub. No.: US 2007/0025346 A1
(43) Pub. Date: Feb. 1, 2007

(54) System and method for creating a routing table

(76) Inventor: Delia Kecskemeti, Kanata (CA)

Correspondence Address: FAY KAPLUN & MARCIN, LLP, 15O BROADWAY, SUITE 702, NEW YORK, NY, 10038, US

(21) Appl. No.: 11/193,964

(22) Filed: Jul. 29, 2005

(51) Int. Cl. H04L 12/28; H04L 12/56

(52) U.S. Cl. 370/389; 370/400

(57) ABSTRACT

A method for retrieving a first entity description for a first entity, the first entity description including a pointer to a second entity description for a second entity, wherein the first entity is connected to the second entity; retrieving the second entity description using the pointer of the first entity description; and building a routing table using information from the first and second entity descriptions.

### BACKGROUND INFORMATION

In a conventional networking system, the Open Shortest Path First (OSPF) routing algorithm is often used to calculate the shortest path between connected elements (e.g., a network, a router, etc.). OSPF is a link state routing protocol that stores information about every known link as a link state advertisement (LSA) within a link state database (LSDB). Using the well-known Dijkstra's algorithm to calculate the shortest path first (SPF), a routing table is computed that contains the shortest routes to every destination. This routing table is then used by the internet protocol (IP) to forward data between elements. Whenever new link information is received, OSPF runs SPF and updates routing table information.

Dijkstra's algorithm inspects every link LSA in the LSDB exactly once. The order in which the LSAs are inspected is not necessarily the same as the order in which the LSAs are stored in the LSDB. The storage order could, for example, be based upon the order of LSA arrival or partitioned by ID-based hashes. Every step during SPF involves two database lookups: one in the LSDB to find the LSA for the element being inspected, and one in the current routing table database to find if a shortest path to that destination has already been found and compare it to the current path. As networks grow larger and more complex, the amount of time needed to calculate routing tables increases correspondingly. Therefore, there is a need for a system which would simplify or make more efficient the SPF calculation used under OSPF. This need is even more evident under OSPFv3, which is designed for IPv6 and involves a more complex LSDB structure than that of the original OSPF and OSPFv2.

### SUMMARY OF THE INVENTION

The present invention is directed to a method for creating a routing table. In particular, the present invention relates to a method for retrieving a first entity description for a first entity, the first entity description including a pointer to a second entity description for a second entity, wherein the first entity is connected to the second entity; retrieving the second entity description using the pointer of the first entity description; and building a routing table using information from the first and second entity descriptions.

The present invention also relates to a system which includes a first entity including a first entity description; a second entity including a second entity description, wherein the first entity is connected to the second entity and the first entity description includes a pointer to the second entity description; and a routing table built from the first and second entity descriptions, wherein the second entity description is accessed for building the routing table via the pointer of the first entity description.

The present invention further relates to a computer system which includes a memory for storing a set of instructions and a processor for executing the set of instructions, the set of instructions being operable to: (1) retrieve a first entity description for a first entity, the first entity description including a pointer to a second entity description for a second entity, wherein the first entity is connected to the second entity; (2) retrieve the second entity description using the pointer of the first entity description; (3) build a routing table using information from the first and second entity descriptions.

### BRIEF DESCRIPTION OF THE DRAWINGS

FIG. 1 shows an exemplary network topology diagram showing various network and router connections.

FIG. 2 shows LSDB information for the exemplary network of FIG. 1 according to the prior art.

FIG. 3 shows LSDB information for the exemplary network of FIG. 1 after LSDB interlinking according to an exemplary embodiment of the present invention.

FIG. 4 shows an exemplary method of converting entity IDs to pointers in a tag-based system according to the present invention.

FIG. 5 shows an exemplary embodiment of a router linked list and a network linked list according to the present invention.

### DETAILED DESCRIPTION

The present invention may be further understood with reference to the following description of exemplary embodiments and the related appended drawings, wherein like elements are provided with the same reference numerals. The present invention is related to methods and systems used to calculate routing tables. More specifically, the present invention is related to systems and methods for routing table calculations utilizing the general OSPF routing protocol. The present invention is further directed to systems and methods specifically utilizing the OSPFv3. protocol.

Under the current method used in OSPF, the SPF algorithm used in calculating routing tables requires searching each of the LSAs in the LSDB exactly once. Under OSPFv3, multiple LSAs are used to describe the same link, and the SPF algorithm used to calculate routing tables requires traversing a set of multiple LSAs for most of the links. According to an exemplary embodiment of the present invention, a system for interlinkage of LSDBs is provided that avoids LSDB lookups. Routing table calculation is thus performed without any LSA lookup operations. The result is an increase in the performance of OSPF routing table computation and decreased SPF algorithm convergence time.

The LSDB interlinkage system according to the present invention may be used effectively to improve the efficiency of OSPF-based networks. As networks become increasingly complex, with more networks being linked together, so does the need to quickly determine the shortest path between linked networks and with a minimum of overhead. Structuring the LSDBs according to the exemplary method of the present invention provides improved calculation performance while minimizing memory usage.

According to the known method of SPF calculation using Dijkstra's algorithm, LSA lookups are performed for each interlinked LSA. This method is exemplified as follows:

Find router LSA of calculating router R in router LSDB

For every network N connected to router R

Find LSA of network N in network LSDB

Verify if best path to N so far, record if best

For every router R connected to network N
Find LSA of router R in router LSDB
Verify if best path to R so far, record if best
For every network N connected to router R ( . . . and so on)

According to the exemplary embodiment of the present invention, the LSDBs are structured to eliminate all of the Find LSA operations. The algorithm for calculating the shortest path according to the embodiment of the present invention is exemplified as follows:

GoTo router LSA of calculating router R in router LSDB

For every network N connected to router R

GoTo LSA of network N in network LSDB

Verify if best path to N so far, record if best

For every router R connected to network N
GoTo LSA of router R in router LSDB
Verify if best path to R so far, record if best
For every network N connected to router R ( . . . and so on)

The replacement of the Find LSA operations with GoTo operations is accomplished using the proposed technique in accordance with the exemplary embodiment of the present invention. The entity IDs associated with connected router and connected network LSAs are replaced with pointers to the LSA describing the entity. This is possible due to the fact that the OSPF entity IDs are 32 bits, which coincides with the size of pointers on the 32-bit machines currently in use. The exemplary method therefore requires no additional memory for storage of pointers.

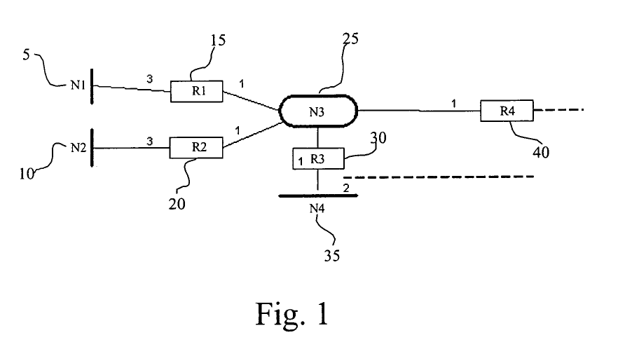

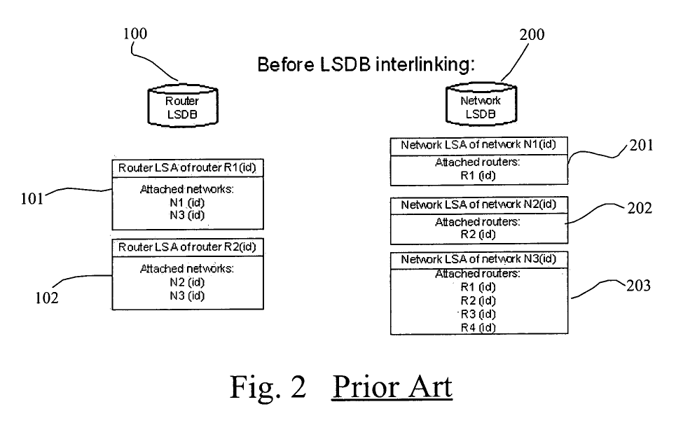

FIG. 1 depicts an exemplary network diagram which includes a network N1 5 connected by a router R1 15 to a network N3 25, a network N2 10 connected by a router R2 20 to the network N3 25, a network N4 35 connected by a router R3 30 to the network N3 25, and a router R4 40 connected to the network N3 25. Based upon the network topology as depicted in FIG. 1, a conventional network information table is presented in FIG. 2. A router LSA 101 is computed for the router R1 15 and shows that the networks N1 5 and N3 25 are connected to the router R1 15. Similarly, a router LSA 102 is computed for the router R2 20 and shows that the networks N2 10 and N3 25 are connected to the router R2 20. Together, the router LSAs 101 and 102 constitute the Router LSDB 100. LSAs for the routers R3 30 and R4 40 are not shown in order to simplify the diagram. However, each of these routers 30 and 40 will also have an associated LSA. A network LSA 201 is computed for the network N1 5 and shows that the router R1 15 is connected to the network N1 5. Similarly, a network LSA 202 is computed for the network N2 10 showing that the router R2 20 is connected to the network N2 10, and a network LSA 203 is computed for the network N3 25 showing that the routers R1 15, R2 20, R3 30, and R4 40 are connected to the network N3 25. The information tables as shown in FIG. 2 represent the status of the LSDBs before interlinking, as they are used under the current SPF algorithm. Each network or router under the current system has an associated ID that uniquely identifies the network or router. The process of determining the connected entities in a LSDB requires LSA lookup of the entity IDs each time the SPF algorithm is run.

The exemplary embodiment of the present invention replaces the entity ID with a pointer allowing the algorithm to go directly to the next LSA by following a pointer link instead of looking up the LSA associated with the entity ID. Without pointer usage, a typical SPF computation would require n LSDB lookups for an LSDB containing n LSAs. Replacement of entity IDs with pointers eliminates all n LSDB lookups. Those skilled in the art will understand that the processing performance of an LSDB lookup algorithm ranges from Order(n) to Order(log (n)) depending on the data structure used to store the LSDB. The performance gain for OSPF convergence through replacement of IDs with pointers is therefore in the range from Order(n*n) to Order(n*log(n)) depending on the particular LSDB implementation to which the method is applied.

Those skilled in the art will understand that the initial state of the network to which the method is applied consists of unlinked LSAs. The linking procedure using the pointer method according to the present invention may be done during the first SPF computation. Accordingly the LSDB lookups associated with the current method of SPF calculation may be performed once, in order to replace the entity IDs and link the LSAs. After interlinkage of the LSAs, the SPF algorithm may then take advantage of the performance gains associated with the exemplary method. Another instance in which LSDB lookups may be performed is when an LSA is added. In the case of a new LSA, which is a rare case event, there would be as many additional lookups as connected entities (e.g., connected routers to a network or connected networks to a router). This may be done once, when the LSA is first received.

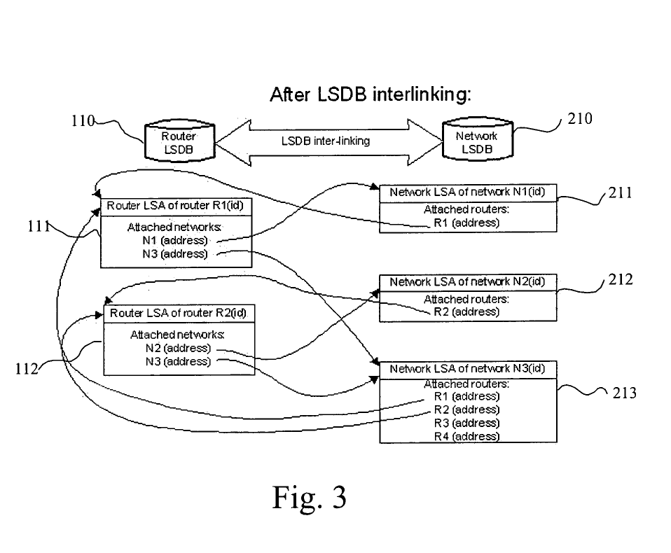

FIG. 3 shows exemplary information tables for the network of FIG. 1 as they are after the LSDB 110 and 210 interlinking performed during the first run of the SPF algorithm. The router LSAs 111 and 112 and the network LSAs 211, 212, and 213 are essentially the same as they are before LSDB interlinking as depicted in FIG. 2, with the exception that instead of IDs being attached to each entity, a pointer is attached to each entity, and with an address associated with each entity. For example, the router LSA 111 includes references to connected networks N1 5 and N3 25, but instead of including the entity IDs of the networks N1 5 and N3 25, the LSA 111 includes pointers to the LSAs of the connected networks N1 5 and N3 25. Thus, instead of performing an LSDB lookup, the routing table can be computed by following the pointers to the required LSAs. FIG. 3 shows the similar replacement of entity IDs with pointers in the LSAs of the networks N1-N3 and the router R2 20.

It should be noted that the proposed embodiments according to the present invention do not make the resulting OSPF implementation non-RFC (Request For Comments) compliant. The entities are still identified between routers by the standard 32-bit IDs, since the local pointers used in the implementation have no meaning for remote routers. However, since the RFCs do not specify how LSAs are to be stored locally, the method in accordance with the present invention may be applied without violating RFC standards. This is true as long as any LSA flooding to outside routers restores the pointer-to-ID conversion by following the pointer and de-referencing the actual ID of the entity.

In an alternative embodiment of the present invention, interlinkage is applied to parts, rather than the entirety of the LSDBs. For example, only certain router LSAs may be converted from IDs to pointers. A tag bit may be used to differentiate between the interlinked and non-interlinked LSAs by toggling one of the unused bits in the LSAs. Thus, if the toggle indicated interlinking, the pointer link would be followed. If the toggle indicated no interlinking, a normal LSDB lookup would be used.

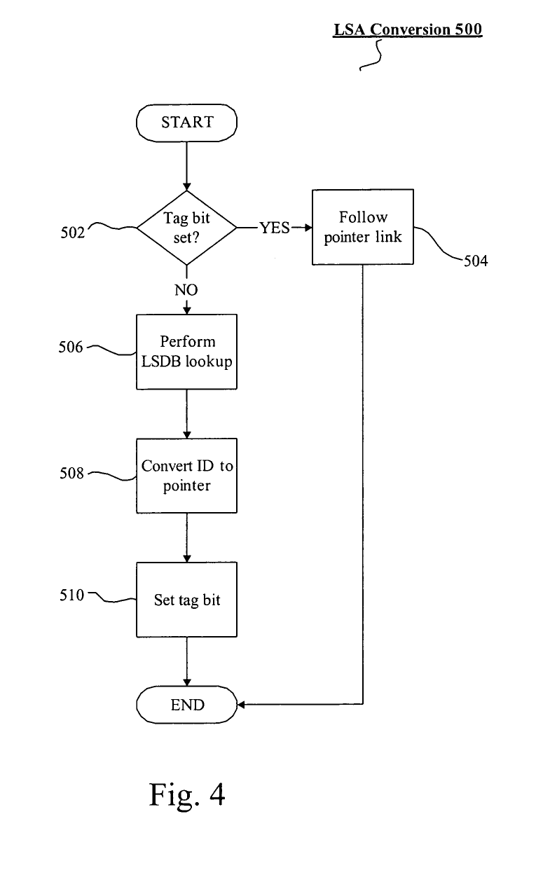

In a further embodiment of the present invention, implicit tagging of the LSAs may be performed as the SPF algorithm progresses through untagged or non-interlinked LSAs. FIG. 4 shows an exemplary method 500 of converting LSA and ID entries to pointers. The method 500 begins by determining if the tag bit is set (step 502). If the tag bit is set, then the LSA has been previously interlinked and the pointer link is followed (step 504) and the method is complete. If the tag bit is not set, then the LSA is not interlinked and an LSDB lookup is performed (step 506). After the lookup is performed, the entity IDs in the LSA are converted into pointers (step 508) in order to interlink the LSA. When all the entity IDs are converted, the LSA is interlinked and the tag bit is set to indicate this interlinking (step 510). Thus, the next time the method 500 is performed on this LSA, the tag bit will be set in step 502 and the pointer will be followed as shown in step 504.

Another method to which the invention is directed relates to OSPFv3 type networks where each entity is described using two types of LSAs. A first type of LSA describes connectivity information, while a second type lists the IPv6 addresses for the entity. During SPF computation, all the LSAs referring to the same entity must be considered as a unique LSA aggregate. For example, for every router there can be a set of router LSAs (type 1) describing all networks connected to the router and a set of intra-area prefix LSAs (type 9) describing all the IPv6 addresses locally assigned to that router, including those for stub networks and hosts. For a network entity, multiple subnets per link are allowed, and the network entity is described by only one network LSA (type 2), and also by a set of intra-area prefix LSAs that describe all the IPv6 addresses assigned to that network by any routers connected to that network.

Due to the use of multiple LSAs for each entity under OSPFv3, SPF performance is affected from having to perform multiple LSDB lookups in order to locate all the LSAs referring to a given entity. Compared to an LSDB containing n LSAs and thus n LSDB lookups under OSPF and OSPFv2, for an average of m LSAs per entity in an LSDB of n elements under OSPFv3, the SPF computation would require m*n LSDB lookups.

An exemplary embodiment of the present invention is directed towards minimizing the performance impact due to OSPFv3 specific LSA aggregation by interlinking all the LSAs that refer to the same entity. The interlinking procedure requires using two additional pointers per LSA, previous and next. The use of the previous and next pointers creates a linked list of LSAs. During SPF calculation, only the first LSA describing the entity must be found, the other LSAs describing the same link may be retrieved directly from the linked list instead of via lookup. Thus, this reduces the number of lookups from n*m to just n. In order to support the two additional pointers, eight (8) additional bytes of memory are needed.

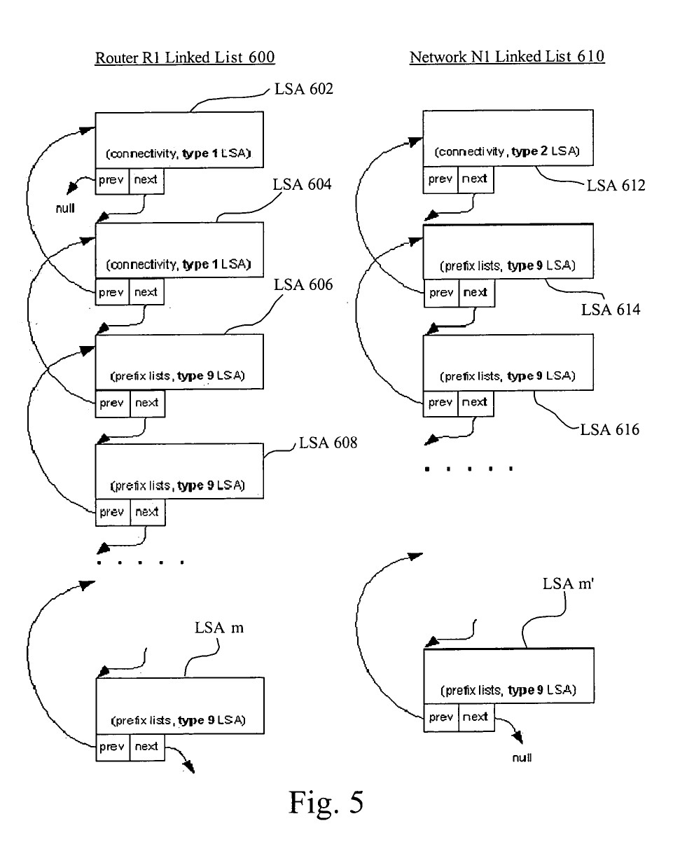

FIG. 5 shows an exemplary representation of a router linked list 600 and a network linked list 610. The LSDB shows that the router R1 15 contains a set of type 1 LSAs, LSAs 602 and 604 and a set of type 9 LSAs, LSAs 606-m. The LSAs describing the network N1 5 includes a single type 2 LSA, LSA 612 and a set of type 9 LSAs, LSAs 614-m′. The linked lists 600 and 610 show that previous and next pointers are assigned to each LSA. Thus, for the router R1 15, the previous pointer for the first LSA 602 is null, while the next pointer of the LSA 602 points to the next LSA 604 in the linked list, and the previous pointer of the LSA 604 points back to the LSA 602. The linkage continues until the last LSA m is reached, and is terminated with the next pointer of the last LSA m being null. The linkage for the network N1 5 is similarly structured.

Thus, it can be seen from the linked lists 600 and 610 that only one LSA describing an entity needs to be found. Once the first LSA is found, the previous and/or next pointers can be traversed to find all the other LSAs associated with the entity. As will be understood by those of skill in the art, the use of the previous and next pointers allows the list to be entered at any point (e.g., LSA), and each LSA in the list can be found. Therefore, the need to do an LSDB lookup for each LSA in the linked list is eliminated.

Those of skill in the art will also understand that the exemplary embodiment uses pointers and a linked list, but any method of chaining the related LSAs together may be used. Furthermore, the exemplary embodiment is described with reference to OSPFv3 and IPv6, but any routing table application which has multiple descriptions for the same entity may benefit from the present invention.

Those of skill in the art will also understand that the address replacement interlinking and the linked list interlinking may be combined, for example, under OSPFv3, so that for OSPFv3, no LSDB lookups would be required during SPF computation. This results in a faster algorithm convergence than if either of the two types of interlinking were used alone.

It will be apparent to those skilled in the art that various modifications may be made in the present invention, without departing from the spirit or scope thereof. Thus, it is intended that the present invention cover the modifications and variations of this invention provided they come within the scope of the appended claims and their equivalents.

What is claimed is:

1. A method, comprising:
retrieving a first entity description for a first entity, the first entity description including a pointer to a second entity description for a second entity, wherein the first entity is connected to the second entity;
retrieving the second entity description using the pointer of the first entity description; and
building a routing table using information from the first and second entity descriptions.

2. The method of claim 1, wherein the first entity is one of a router and a network.

3. The method of claim 1, wherein the first entity description is a link state advertisement (LSA).

4. The method of claim 3, wherein the LSA is a table.

5. The method of claim 1, wherein the pointer is a 32-bit pointer.

6. The method of claim 1, wherein the first entity description includes a plurality of pointers to further entity descriptions, wherein each of the further entity descriptions corresponds to one of the further entities.

7. The method of claim 1, further comprising:
replacing an entity ID of the second entity with the pointer in the first entity description.

8. The method of claim 7, further comprising:
setting an indication of the first entity description when the entity is replaced.

9. The method of claim 1, wherein the routing table is an OSPF routing table.

10. A system, comprising:
a first entity including a first entity description;
a second entity including a second entity description, wherein the first entity is connected to the second entity and the first entity description includes a pointer to the second entity description; and
a routing table built from the first and second entity descriptions, wherein the second entity description is accessed for building the routing table via the pointer of the first entity description.

11. The system of claim 10, wherein the first entity is one of a router and a network.

12. The system of claim 10, wherein the first entity description is a link state advertisement (LSA).

13. The system of claim 12, wherein the LSA is a table.

14. The system of claim 10, wherein the pointer is a 32-bit pointer.

15. The system of claim 10, further comprising:
a further plurality of entities, each further entity including a further entity description, wherein the first entity description includes a further plurality of pointers, each further pointer corresponding to one of the further entity descriptions.

16. The system of claim 10, wherein an entity ID of the second entity is replaced with the pointer in the first entity description.

17. The system of claim 10, wherein the routing table is an OSPF routing table.

18. A computer system comprising a memory for storing a set of instructions and a processor for executing the set of the instructions, the set of instructions being operable to:
retrieve a first entity description for a first entity, the first entity description including a pointer to a second entity description for a second entity, wherein the first entity is connected to the second entity;
retrieve the second entity description using the pointer of the first entity description; and
build a routing table using information from the first and second entity descriptions.

19. The computer system of claim 18, wherein the first entity description is a link state advertisement (LSA).

20. The computer system of claim 18, wherein the routing table is an OSPF routing table.
